(19) United States
(12) Patent Application Publication
(10) Pub. No.: US 2026/0357644 A1
(43) Pub. Date: Nov. 12, 2026

(54) GLASS UNIT

(71) Applicant: CORNING INCORPORATED, CORNING, NY (US)

(72) Inventors: Jae-Young Choi, Seoul (KR); Gun-hoa Lee, Gyeonggi-do (KR)

(21) Appl. No.: 19/470,128

(22) PCT Filed: Apr. 5, 2024
(86) PCT No.: PCT/US2024/023351

§ 371 Date: Sep. 29, 2025

(30) Foreign Application Priority Data
Apr. 6, 2023 (KR) 10-2023-0045527

(51) Int. Cl. E06B 3/663; E06B 3/67; E06B 3/673

(52) U.S. Cl. CPC E06B 3/66366; E06B 3/6715; E06B 3/67326; E06B 3/67343

(57) ABSTRACT

Provided is a glass unit including a first outer glass plate and a second outer glass plate facing each other, an inner glass plate arranged between the first outer glass plate and the second outer glass plate, a first spacer arranged between the first outer glass plate and the inner glass plate to space the inner glass plate apart from the first outer glass plate, a second spacer arranged between the second outer glass plate and the inner glass plate to space the inner glass plate apart from the second outer glass plate, and a sealing member buried in a space between the first outer glass plate and the inner glass plate and a space between the second outer glass plate and the inner glass plate, wherein an upper surface of the sealing member includes a curved surface that is concavely formed.

### CROSS-REFERENCE TO RELATED APPLICATIONS

This application claims the benefit of priority under 35 U.S.C. § 119 of Korean Application No. 10-2023-0045527 filed Apr. 6, 2023, the content of which is incorporated herein by reference in its entirety.

### BACKGROUND

### 1. Field

The disclosure relates to a glass unit, and more particularly, to a multilayer glass unit including two outer glass plates and at least one inner glass plate.

### 2. Description of the Related Art

A multilayer glass unit including a plurality of glass plates may be effective in insulation, soundproofing, and/or condensation prevention. Multilayer glass units as described above may be used for buildings, transportation such as cars, trains, and airplanes, or windows of electronic apparatuses such as refrigerators and freezers. In general, as the number of glass plates constituting a multilayer glass unit increases, the performance of insulation, soundproofing, and/or condensation prevention may be improved, but the weight of the multilayer glass unit may increase.

### SUMMARY

Provided are a multilayer glass unit having light weight and improved durability, and a method of manufacturing the glass unit.

Additional aspects will be set forth in part in the description which follows and, in part, will be apparent from the description, or may be learned by practice of the presented embodiments of the disclosure.

According to an aspect of the disclosure, a glass unit includes a first outer glass plate and a second outer glass plate facing each other, an inner glass plate arranged between the first outer glass plate and the second outer glass plate, a first spacer arranged between the first outer glass plate and the inner glass plate to space the inner glass plate apart from the first outer glass plate, a second spacer arranged between the second outer glass plate and the inner glass plate to space the inner glass plate apart from the second outer glass plate, and a sealing member buried in a space between the first outer glass plate and the inner glass plate and a space between the second outer glass plate and the inner glass plate, wherein an upper surface of the sealing member includes a curved surface that is concavely formed.

An upper surface of the first outer glass plate may be located on a same plane as an upper surface of the second outer glass plate, and an upper surface of the inner glass plate may be offset from the upper surface of the first outer glass plate by a first distance.

A lowest point of the upper surface of the sealing member may be offset from the upper surface of the first outer glass plate by a second distance, and the first distance may be greater than the second distance.

A central point of the upper surface of the sealing member may include the lowest point of the upper surface of the sealing member.

A thickness of the inner glass plate may be smaller than each of a thickness of the first outer glass plate and a thickness of the second outer glass plate, and a composition of the inner glass plate may be different from each of a composition of the first outer glass plate and a composition of the second outer glass plate.

The thickness of the inner glass plate may be about 0.2 mm to about 1.0 mm.

A bottom surface of the sealing member opposite to the upper surface of the sealing member may have an uneven shape.

Each of the first outer glass plate and the second outer glass plate may include soda lime glass, and the inner glass plate may include boroaluminosilicate glass.

A thermal expansion coefficient of the inner glass plate may be smaller than each of a thermal expansion coefficient of the first outer glass plate and a thermal expansion coefficient of the second outer glass plate.

Both outer surfaces of the sealing member may be in contact with the first outer glass plate and the second outer glass plate, respectively.

According to another aspect of the disclosure, a glass unit includes a first outer glass plate and a second outer glass plate facing each other, a first inner glass plate arranged between the first outer glass plate and the second outer glass plate, a first spacer arranged between the first outer glass plate and the first inner glass plate to space the first inner glass plate apart from the first outer glass plate, a second spacer arranged between the second outer glass plate and the first inner glass plate to space the first inner glass plate apart from the second outer glass plate, and a sealing member buried in a space between the first outer glass plate and the first inner glass plate and a space between the second outer glass plate and the first inner glass plate, wherein a circumference of the first inner glass plate is offset inward from a circumference of the first outer glass plate and a circumference of the second outer glass plate, and an upper surface of the sealing member includes a curved surface that is concavely formed.

The glass unit may further include a second inner glass plate arranged between the first inner glass plate and the second outer glass plate, and spaced apart from the first inner glass plate by the second spacer, and a third spacer arranged between the second outer glass plate and the second inner glass plate to space the second inner glass plate apart from the second outer glass plate.

A distance between a vertical level of an upper surface of the first inner glass plate and a vertical level of an upper surface of the first outer glass plate may be greater than a distance between a vertical level of an upper surface of the first spacer and the vertical level of the upper surface of the first outer glass plate.

The upper surface of the first inner glass plate may be offset from the upper surface of the first outer glass plate by a first distance, a lowest point of the upper surface of the sealing member may be offset from the upper surface of the first outer glass plate by a second distance, and the first distance may be greater than the second distance.

The first spacer and the second spacer may contact each other.

A solar absorption rate of the first inner glass plate may be lower than each of a solar absorption rate of the first outer glass plate and a solar absorption rate of the second outer glass plate.

A solar transmittance of the first inner glass plate may be greater than each of a solar transmittance of the first outer glass plate and a solar transmittance of the second outer glass plate.

According to another aspect of the disclosure, a method of manufacturing a glass unit includes attaching a first spacer onto an inner glass plate, attaching the inner glass plate onto the first outer glass plate via the first spacer such that a circumference of the inner glass plate is offset inward from a circumference of the first outer glass plate, attaching a second spacer onto a second outer glass plate, attaching the second outer glass plate to the inner glass plate via the second spacer such that the circumference of the inner glass plate is offset inward from a circumference of the second outer glass plate, on an upper surface of the first spacer and an upper surface of the second spacer, filling, via a sealing material nozzle block, a sealing material into a space between the first outer glass plate and the second outer glass plate, and forming a sealing member by filling the sealing material in the space between the first outer glass plate and the second outer glass plate.

A bottom surface of the sealing material nozzle block in contact with an upper surface of the sealing member may include a curved surface that is convexly formed toward the inner glass plate.

The upper surface of the sealing member may include a curved surface that is concavely formed toward the inner glass plate.

Additional features and advantages will be set forth in the detailed description which follows and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure as it is claimed.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

The above and other aspects, features, and advantages of certain embodiments of the disclosure will be more apparent from the following description taken in conjunction with the accompanying drawings, in which:

FIG. 1A is a plan view of a glass unit according to an embodiment;

FIG. 1B is a cross-sectional view taken along line B1-B1′ of FIG. 1A;

FIG. 1C is an enlarged view of a portion C1 of FIG. 1B;

FIG. 2A is a cross-sectional view of a glass unit according to an embodiment;

FIG. 2B is an enlarged view of a portion C2 of FIG. 2A;

FIG. 3A is a plan view of a glass unit according to an embodiment;

FIG. 3B is a cross-sectional view taken along line B2-B2′ of FIG. 3A;

FIG. 3C is an enlarged view of a portion C3 of FIG. 3B;

FIG. 4A is a cross-sectional view of a glass unit according to an embodiment;

FIG. 4B is an enlarged view of a portion C4 of FIG. 4A; and

FIGS. 5A to 5G are cross-sectional views sequentially illustrating a process of manufacturing a glass unit, according to an embodiment. FIGS. 5A to 5G are cross-sectional views sequentially illustrating a process of manufacturing the glass unit having three panes, a first spacer, and a second spacer with the embodied configurations described herein, in accordance with various aspects of the present disclosure, While the sequence of FIGS. 5A-G depict a sequence having a particular configuration of the first spacer, inner pane, and second spacer, with regard to one or more various alternative embodiments shown and described herein, the sequence is easily understood to represent a sealing member configured adjacent to the first outer pane, the second outer pane, and at least one of: the first spacer and second spacer; the first spacer, the upper edge of the inner pane, and the second spacer; a single spacer (the first spacer) and the inner pane; and a single spacer (inner pane is retained by single spacer and is not in contact with the sealing member).

FIG. 5A depicts a first sequence, in which a first spacer is applied to an inner glass pane and the inner glass pane is aligned with the first outer glass plate, in accordance with various aspects of the present disclosure.

FIG. 5B depicts a second sequence, in which a first spacer is applied to the first outer glass pane, to define a sealed space between the first outer glass plate, the first spacer, and the inner glass plate, in accordance with various aspects of the present disclosure.

FIG. 5C depicts a third sequence, in which a second spacer is applied to the other side of the inner glass pane and the inner glass pane is aligned with the second outer glass plate, in accordance with various aspects of the present disclosure.

FIG. 5D depicts a fourth sequence, in which a second spacer is applied to the second outer glass pane, to define a sealed space between the second outer glass plate, the second spacer, and the inner glass plate, in accordance with various aspects of the present disclosure.

FIG. 5E depicts a fifth sequence, in which a sealing member manufacturing equipment is shown directing the sealing member into the space between the first outer pane and the second outer pane to define a sealing member that spans between the first outer pane and the second outer pane in the region between the outer edges of each pane and the outermost edges of the inner pane and/or spacer(s), in accordance with various aspects of the present disclosure.

FIG. 5F depicts a sixth sequence, in which the resulting sealing member is depicted, configured between the first outer plate and the second outer plate, configured as a monolithic, integral body, and/or such that via the sealing member manufacturing equipment, the upper outer edge/profile of the sealing member is configured in a concave manner, in accordance with various aspects of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described in detail with reference to the accompanying drawings. However, the disclosure should not be configured as limited to the embodiments described below, and may be embodied in various other forms. The embodiments below are provided to fully convey the scope of the disclosure to those skilled in the art, rather than to perfectly complete the disclosure.

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. As a non-limiting example, about means less than 10% of the referenced value.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise,

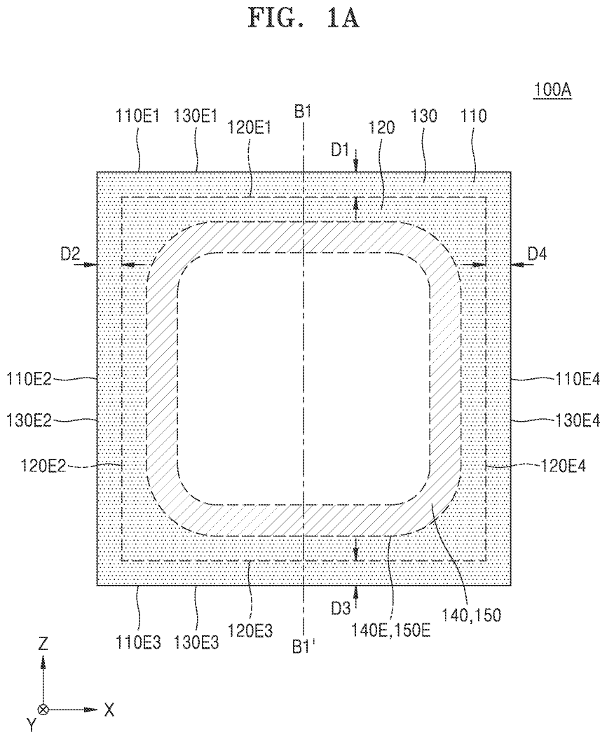

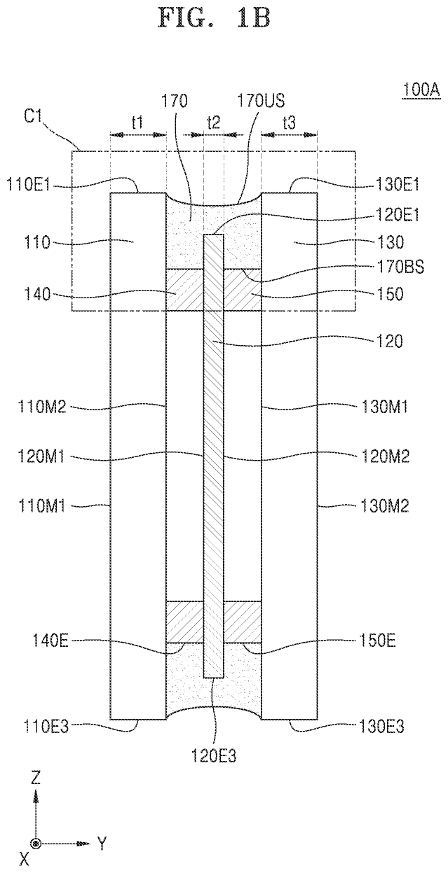

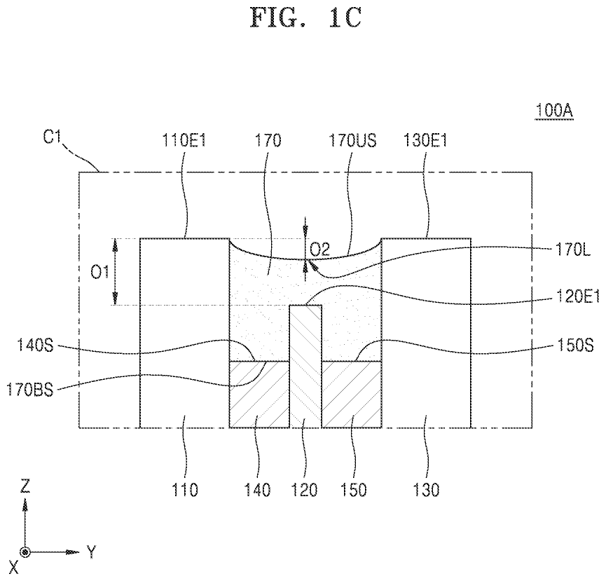

FIG. 1A is a plan view of a glass unit according to an embodiment, and FIG. 1B is a cross-sectional view taken along line B1-B1′ of FIG. 1A. In addition, FIG. 1C is an enlarged view of a portion C1 of FIG. 1B.

Referring to FIGS. 1A to 1C, a glass unit 100A may include a plurality of glass plates 110, 120, and 130. For example, the glass unit 100A may include a first outer glass plate 110, an inner glass plate 120, and a second outer glass plate 130. Each of the first outer glass plate 110 and the second outer glass plate 130 may be referred to as an outer glass plate, and the inner glass plate 120 located between the first outer glass plate 110 and the second outer glass plate 130 may be referred to as an inner glass plate.

The first outer glass plate 110 may include two main surfaces (i.e., a first main surface 110M1 and a second main surface 110M2) facing each other, and a circumference that surrounds the first main surface 110M1 and the second main surface 110M2. The circumference of the first outer glass plate 110 may include at least one edge surface (i.e., a first edge surface 110E1, a second edge surface 110E2, a third edge surface 110E3, and/or a fourth edge surface 110E4) between the first main surface 110M1 and the second main surface 110M2. For example, each of the first main surface 110M1 and the second main surface 110M2 of the first outer glass plate 110 may have a rectangular shape, and the circumference of the first outer glass plate 110 may include the first to fourth edge surfaces 110E1 to 110E4. In an embodiment, each of the first main surface 110M1 and the second main surface 110M2 of the first outer glass plate 110 may have a shape different from the rectangular shape, and the number of edge surfaces constituting the circumference of the first outer glass plate 110 may be greater or less than 4. In some embodiments, the first main surface 110M1 and the second main surface 110M2 of the first outer glass plate 110 may be substantially parallel to each other. In an embodiment, the first main surface 110M1 and the second main surface 110M2 of the first outer glass plate 110 may not be substantially parallel to each other.

Similarly, the second outer glass plate 130 may include two main surfaces (i.e., a first main surface 130M1 and a second main surface 130M2) facing each other, and a circumference that surrounds the first main surface 130M1 and the second main surface 130M2. The circumference of the second outer glass plate 130 may include at least one edge surface (i.e., a first edge surface 130E1, a second edge surface 130E2, a third edge surface 130E3, and/or a fourth edge surface 130E4) between the first main surface 130M1 and the second main surface 130M2. For example, each of the first main surface 130M1 and the second main surface 130M2 of the second outer glass plate 130 may have a rectangular shape, and the circumference of the second outer glass plate 130 may include the first to fourth edge surfaces 130E1 to 130E4. In an embodiment, each of the first main surface 130M1 and the second main surface 130M2 of the second outer glass plate 130 may have a shape different from the rectangular shape, and the number of edge surfaces constituting the circumference of the second outer glass plate 130 may be greater or less than 4. In some embodiments, the first main surface 130M1 and the second main surface 130M2 of the second outer glass plate 130 may be substantially parallel to each other. In an embodiment, the first main surface 130M1 and the second main surface 130M2 of the second outer glass plate 130 may not be substantially parallel to each other.

The inner glass plate 120 may include two main surfaces (i.e., a first main surface 120M1 and a second main surface 120M2) facing each other, and a circumference that surrounds the first main surface 120M1 and the second main surface 120M2. The circumference of the inner glass plate 120 may include at least one edge surface (i.e., a first edge surface 120E1, a second edge surface 120E2, a third edge surface 120E3, and/or a fourth edge surface 120E4) between the first main surface 120M1 and the second main surface 120M2. For example, each of the first main surface 120M1 and the second min surface 120M2 of the inner glass plate 120 may have a rectangular shape, and the circumference of the inner glass plate 120 may include the first to fourth edge surfaces 120E1 to 120E4. In an embodiment, each of the first main surface 120M1 and the second main surface 120M2 of the inner glass plate 120 may have a shape different from the rectangular shape, and the number of edge surfaces constituting the circumference of the inner glass plate 120 may be greater or less than 4. In some embodiments, the first main surface 120M1 and the second main surface 120M2 of the inner glass plate 120 may be substantially parallel to each other. In an embodiment, the first main surface 120M1 and the second main surface 120M2 of the inner glass plate 120 may not be substantially parallel to each other.

The first main surface 120M1 of the inner glass plate 120 may face the second main surface 110M2 of the first outer glass plate 110, and the second main surface 120M2 of the inner glass plate 120 may face the first main surface 130M1 of the second outer glass plate 130. In some embodiments, the first main surface 120M1 of the inner glass plate 120 may be substantially parallel to the second main surface 110M2 of the first outer glass plate 110, and the second main surface 120M2 of the inner glass plate 120 may be substantially parallel to the first main surface 130M1 of the second outer glass plate 130. In an embodiment, the first main surface 120M1 of the inner glass plate 120 may not be substantially parallel to the second main surface 110M2 of the first outer glass plate 110, and the second main surface 120M2 of the inner glass plate 120 may not be substantially parallel to the first main surface 130M1 of the second outer glass plate 130.

In some embodiments, a thickness t1 of the first outer glass plate 110 between the first main surface 110M1 and the second main surface 110M2 of the first outer glass plate 110 and a thickness t3 of the second outer glass plate 130 between the first main surface 130M1 and the second main surface 130M2 of the second outer glass plate 130 may each be about 1 mm to about 50 mm. In some embodiments, a thickness t2 of the inner glass plate 120 between the first main surface 120M1 and the second main surface 120M2 of the inner glass plate 120 may be smaller than each of the thickness t1 of the first outer glass plate 110 and the thickness t3 of the second outer glass plate 130. For example, the thickness t2 of the inner glass plate 120 may be about 0.2 mm to about 1.0 mm. As the thickness t2 of the inner glass plate 120 decreases, a weight of the glass unit 100A may decrease, and a light transmittance of the glass unit 100A may increase. Therefore, the decrease in the thickness t2 of the inner glass plate 120 may further improve the durability of the glass unit 110A. For example, when the thickness t2 of the inner glass plate 120 is about 1/10 of each of the thickness t1 of the first outer glass plate 110 and the thickness t3 of the second outer glass plate 130, the weight of the glass unit 100A may be reduced by about 30% than when the thickness t2 of the inner glass plate 110 is the same as each of the thickness t1 of the first outer glass plate 110 and the thickness t3 of the second outer glass plate 130. In addition, as the thickness t2 of the inner glass plate 120 decreases, a thickness of a gas layer between the second main surface 110M2 of the first outer glass plate 110 and the first main surface 120M1 of the inner glass plate 120 and a thickness of a gas layer between the second main surface 120M2 of the inner glass plate 120 and the first main surface 130M1 of the second outer glass plate 130 may increase, and thus, the performance of insulation may increase. However, as the thickness t2 of the inner glass plate 120 decreases, the inner glass plate 120 may not be easily handled. In particular, when the thickness t2 of the inner glass plate 120 is less than about 1.0 mm, a strengthening process, such as heat-strengthening or chemical strengthening, may not be easily performed. In some embodiments, the inner glass plate 120 may not undergo a strengthening process such as heat-strengthening or chemical strengthening. Therefore, in this case, the thickness t2 of the inner glass plate 120 may be less than or equal to about 1.0 mm. However, when the thickness t2 of the inner glass plate 120 is less than about 0.2 mm, handling of the inner glass plate 120 may not be easy, and thus, manufacturing of the glass unit 100A may not be easy. Accordingly, the thickness t2 of the inner glass plate 120 may be greater than or equal to about 0.2 mm.

When the thickness t2 of the inner glass plate 120 is less than each of the thickness t1 of the first outer glass plate 110 and the thickness t3 of the second outer glass plate 130, the inner glass plate 120 may be more vulnerable to damage due to physical contact and/or impact than the first outer glass plate 110 and the second outer glass plate 130. Here, the circumference of the inner glass plate 120 may be offset inward from the circumference of the first outer glass plate 110 and the circumference of the second outer glass plate 130, to protect the inner glass plate 120 from physical contact and/or impact. For example, the first edge surface 120E1 of the inner glass plate 120 may be offset inward (in a −Z direction) from the first edge surface 110E1 of the first outer glass plate 110 and the first edge surface 130E1 of the second outer glass plate 130. The second edge surface 120E2 of the inner glass plate 120 may be offset inward (in a +X direction) from the second edge surface 110E2 of the first outer glass plate 110 and the second edge surface 130E2 of the second outer glass plate 130. The third edge surface 120E3 of the inner glass plate 120 may be offset inward (in a +Z direction) from the third edge surface 110E3 of the first outer glass plate 110 and the third edge surface 130E3 of the second outer glass plate 130. The fourth edge surface 120E4 of the inner glass plate 120 may be offset inward (in a −X direction) from the fourth edge surface 110E4 of the first outer glass plate 110 and the fourth edge surface 130E4 of the second outer glass plate 130.

In some embodiments, a distance D1 by which the first edge surface 120E1 of the inner glass plate 120 is offset inward (in the −Z direction) from the first edge surface 110E1 of the first outer glass plate 110 and the first edge surface 130E1 of the second outer glass plate 130, a distance D2 by which the second edge surface 120E2 of the inner glass plate 120 is offset inward (in the +X direction) from the second edge surface 110E2 of the first outer glass plate 110 and the second edge surface 130E2 of the second outer glass plate 130, a distance D3 by which the third edge surface 120E3 of the inner glass plate 120 is offset inward (in the +Z direction) from the third edge surface 110E3 of the first outer glass plate 110 and the third edge surface 130E3 of the second outer glass plate 130, and a distance D4 by which the fourth edge surface 120E4 of the inner glass plate 120 is offset inward (in the −X direction) from the fourth edge surface 110E4 of the first outer glass plate 110 and the fourth edge surface 130E4 of the second outer glass plate 130 may be substantially the same as one another. In an embodiment, at least one pair of the distance D1 by which the first edge surface 120E1 of the inner glass plate 120 is offset inward (in the −Z direction) from the first edge surface 110E1 of the first outer glass plate 110 and the first edge surface 130E1 of the second outer glass plate 130, the distance D2 by which the second edge surface 120E2 of the inner glass plate 120 is offset inward (in the +X direction) from the second edge surface 110E2 of the first outer glass plate 110 and the second edge surface 130E2 of the second outer glass plate 130, the distance D3 by which the third edge surface 120E3 of the inner glass plate 120 is offset inward (in the +Z direction) from the third edge surface 110E3 of the first outer glass plate 110 and the third edge surface 130E3 of the second outer glass plate 130, and the distance D4 by which the fourth edge surface 120E4 of the inner glass plate 120 is offset inward (in the −X direction) from the fourth edge surface 110E4 of the first outer glass plate 110 and the fourth edge surface 130E4 of the second outer glass plate 130 may be substantially different from each other. Each of the distances D1 to D4 of the offsets may be about 0.1 mm to about 100 mm, e.g., about 0.5 mm to about 10 mm or about 1 mm to about 5 mm.

In some embodiments, an area of the inner glass plate 120, e.g., an area of each of the first main surface 120M1 and the second main surface 120M2 of the inner glass plate 120, may be smaller than each of an area of the first outer glass plate 110, e.g., an area of each of first main surface 110M1 and the second main surface 110M2 of the first outer glass plate 110, and an area of the second outer glass plate 130, e.g., an area of each of the first main surface 130M1 and the second main surface 130M2 of the second outer glass plate 130. In some embodiments, a length of the inner glass plate 120 in a Z direction may be shorter than each of a length of the first outer glass plate 110 in the Z direction and a length of the second outer glass plate 130 in the Z direction, and a width of the inner glass plate 120 in an X direction may be smaller than each of a width of the first outer glass plate 110 in the X direction and a width of the second outer glass plate 130 in the X direction.

Each of the first outer glass plate 110, the inner glass plate 120, and the second outer glass plate 130 may include any glass material that includes soda lime, borosilicate glass, alumino silicate glass, boroaluminosilicate glass, or a combination thereof. In some embodiments, the first outer glass plate 110 and the second outer glass plate 130 may include soda lime glass commonly used for windows, and the inner glass plate 120 may include boroaluminosilicate glass. The inner glass plate 120 may be, for example, Eagle XG® that may be obtained from Corning Incorporated.

When the inner glass plate 120 includes boroaluminosilicate glass, the thickness of the inner glass plate 120 may be excessively small (e.g., may be less than or equal to 1.0 mm), and thus, the inner glass plate 120 may not undergo a strengthening process. Even in this case, a thermal expansion coefficient (e.g., about 3×10-6/°C to about 4×10-6/°C) of the boroaluminosilicate glass may be lower than a thermal expansion coefficient (e.g., about 9×10-6/°C to about 1×10-5/°C) of the soda lime, and thus, thermal stress due to a temperature difference within the inner glass plate 120 may be reduced. Accordingly, the possibility of occurrence of thermal damage due to the temperature difference within the inner glass plate 120 may be reduced.

In some embodiments, the combination of materials and configuration promote promote stabilization, sufficient structural support, and/or appropriate positioning of the large architecturally-sized cross-sectionally thin glass substrate as it enters, is processed, exits, and is stored via the system components and/or related method steps, resulting in a thin triple IGU (two outer panes and a thin, inset central pane) that is architecturally-sized. In some embodiments, thin glass has a thickness of not greater than 3 mm to not less than 0.3 mm; or not greater than 2.5 mm to not less than 0.5 mm; or not less than 2.2 mm to not less than 0.5 mm; or not greater than 1.6 mm to not less than 0.5 mm; or not greater than 1.3 mm to not less than 0.5 mm; or not greater than 1 mm to not less than 0.5 mm or not greater than 0.9 mm to not less than 0.4 mm or between about 0.8 mm and about 0.4 mm.

In some embodiments, an architecturally-sized glazing or glass pane has a large areal-dimension (length X width), e.g. relative to consumer electronics technologies. In some embodiments, an architecturally sized cross-sectionally thin pane of glass is configured with: one edge having a length of: at least 1 foot, at least 3 feet, at least 5 feet, at least 7 feet, or at least 10 feet; when configured in a product, sized for windows (3′×5′, 5′×7′), doors, patio doors, or curtain walls.

When the thickness and/or composition of the inner glass plate 120 is different from the thickness and/or composition of each of the first outer glass plate 110 and the second outer glass plate 130, a solar transmittance of the inner glass plate 120 may be greater than each of a solar transmittance of the first outer glass plate 110 and a solar transmittance of the second outer glass plate 130. For example, the solar transmittance of the inner glass plate 120 may be about 90% to about 95%, and the solar transmittance of each of the first outer glass plate 110 and the second outer glass plate 130 may be about 75% to about 85%. Accordingly, a light transmittance of the glass unit 100A may increase more than when the inner glass plate 120 has the same thickness and composition as each of the first outer glass plate 110 and the second outer glass plate 130.

In addition, when the thickness and/or composition of the inner glass plate 120 is different from the thickness and/or composition of each of the first outer glass plate 110 and the second outer glass plate 130, a solar absorption rate of the inner glass plate 120 may be lower than each of a solar absorption rate of the first outer glass plate 110 and a solar absorption rate of the second outer glass plate 130. For example, the solar absorption rate of the inner glass plate 120 may be about 0.1% to about 1.0%, and the solar absorption rate of each of the first outer glass plate 110 and the second outer glass plate 130 may be about 5.0% to about 15.0%. In the disclosure, a solar spectrum uses the NFRC100-2010 standard. When the solar absorption rate of the inner glass plate 120 is low, an increase in temperature of the inner glass plate 120 may not be great when the inner glass plate 120 is exposed to sunlight, and thus, the risk of thermal breakage of the internal glass plate 120 may be low.

In addition, when the composition of the inner glass plate 120 is different from the composition of each of the first outer glass plate 110 and the second outer glass plate 130, a density of the inner glass plate 120 may be lower than each of a density of the first outer glass plate 110 and a density of the second outer glass plate 130. For example, the density of the inner glass plate 120 including the boroaluminosilicate glass may be about 2.3 g/cm3 to about 2.5 g/cm3, and the density of each of the first outer glass plate 110 and the second outer glass plate 130 including the soda lime glass may be about 2.5 g/cm3 to about 2.6 g/cm3. When the density of the inner glass plate 120 is low, the weight of the inner glass plate 120 may decrease, and thus, the weight of the glass unit 100A may decrease.

The glass unit 100A may further include a plurality of spacers (i.e., a first spacer 140 and a second spacer 150) for spacing a plurality of glass plates (i.e., the first outer glass plate 110, the inner glass plate 120, and the second outer glass plate 130) apart from one another. The first outer glass plate 110 and the inner glass plate 120 may be spaced apart from each other by the first spacer 140. In other words, the first spacer 140 may be located between the first outer glass plate 110 and the inner glass plate 120. The second outer glass plate 130 and the inner glass plate 120 may be spaced apart from each other by the second spacer 150. In other words, the second spacer 150 may be located between the second outer glass plate 130 and the inner glass plate 120. The first spacer 140 and the second spacer 150 may include any material, for example, metal such as aluminum, or a plastic composite material such as a warm edge spacer. Each of a space defined by the first outer glass plate 110, the inner glass plate 120, and the first spacer 140 and a space defined by the inner glass plate 120, the second outer glass plate 130, and the second spacer 150 may be filled with a gas that may include air, an inert gas such as Ar or Kr, or a combination thereof. The gas may improve the insulation performance of the glass unit 100A.

In some embodiments, the first spacer 140 and the second spacer 150 may not protrude outside the circumference of the inner glass plate 120. In addition, in some embodiments, a circumference 140E of the first spacer 140 and a circumference 150E of the second spacer 150 may be offset inward from the circumference of the inner glass plate 120. For example, the circumference 140E of the first spacer 140 and the circumference 150E of the second spacer 150 may be offset inward (in the −Z direction) from the third edge surface 120E3 of the inner glass plate 120.

According to an embodiment, the glass unit 100A may include a sealing member 170 buried in a space between the first outer glass plate 110 and the inner glass plate 120 and a space between the second outer glass plate 130 and the inner glass plate 120. In this case, the sealing member 170 may cover the upper surface of the inner glass plate 120. In addition, the sealing member 170 may cover the upper surface of each of the first spacer 140 and the second spacer 150. The upper surface of each of the inner glass plate 120, the first spacer 140, and the second spacer 150 referred to herein may be a surface facing the outside of the glass unit 100A. The sealing member 170 may prevent insulation performance of the glass unit 100A from deteriorating due to the flow of moisture into the space defined by the first outer glass plate 110, the inner glass plate 120, and the first spacer 140 or the space defined by the inner glass plate 120, the second outer glass plate 130, and the second spacer 150, or the leakage of gases within the space defined by the first outer glass plate 110, the inner glass plate 120, and the first spacer 140 or the space defined by the inner glass plate 120, the second outer glass plate 130, and the second spacer 150 out of the glass unit 100A. The sealing member 170 may include, for example, a silicone resin or a polysulfide resin.

According to an embodiment, an upper surface 170US of the sealing member 170 may be a curved surface that is concavely formed. Here, a central point of the upper surface 170US of the sealing member 170 may be a lowest point 170L on the upper surface 170US of the sealing member 170. In other words, the central point of the upper surface 170US of the sealing member 170 may be a portion having a shortest vertical distance from the upper surface 170US of the sealing member 170 to the inner glass plate 120. In other words, the sealing member 170 may have an upper surface having a symmetrical shape with respect to the lowest point 170L of the upper surface 170US of the sealing member 170. However, according to embodiments, the central point of the upper surface 170US of the sealing member 170 may be a portion forming an asymmetrical shape, rather than the portion having the shortest vertical distance from the upper surface 170US of the sealing member 170 to the inner glass plate 120.

The upper surface 170US of the sealing member 170 may be a surface facing the outside of the glass unit 100A. The lowest point 170L of the upper surface 170US of the sealing member 170 may be offset from upper surfaces of the first outer glass plate 110 and the second outer glass plate 130 by a second distance O2, and the second distance O2 may be shorter than a first distance O1. The upper surface 170US of the sealing member 170 is the curved surface that is concavely formed, and thus, even when the glass unit 100A collides with an external object, the sealing member 170 may not collide with the external object or may receive less impact from the external object. Accordingly, the upper surface 170US of the sealing member 170 may be concavely formed, and thus may receive less impact from the outside. Therefore, the internal glass plate 120 located between the first outer glass plate 110 and the second outer glass plate 130 may be protected from external impact. A bottom surface 170BS of the sealing member 170 may be a surface opposite to the upper surface 170US of the sealing member 170 exposed to the outside. The bottom surface 170BS of the sealing member 170 may contact the inner glass plate 120, the first spacer 140, and the second spacer 150. The bottom surface 170BS of the sealing member 170 may extend along upper surfaces of the first spacer 140 and the second spacer 150, and a portion of an upper surface and side surface of the inner glass plate 120. Accordingly, the bottom surface 170BS of the sealing member 170 may have an uneven shape.

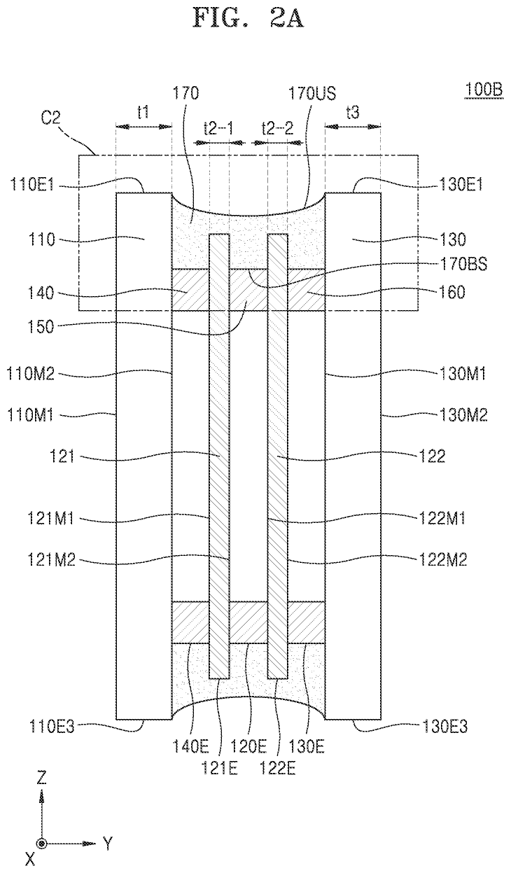

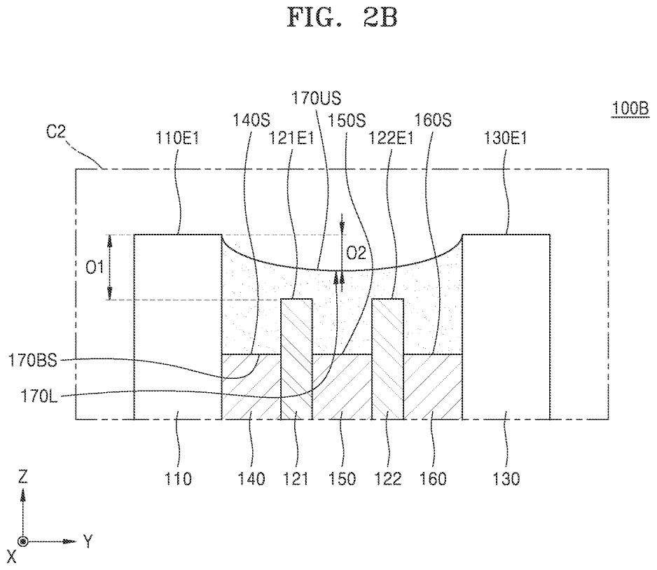

FIG. 2A is a cross-sectional view of a glass unit 100B according to an embodiment, and FIG. 2B is an enlarged view of a portion C2 of FIG. 2A. FIG. 2A corresponds to the cross-sectional view of the glass unit 100A according to an embodiment, illustrated in FIG. 1B. Hereinafter, the description of FIGS. 2A and 2B will be given on the basis of differences from the glass unit 100A illustrated in FIGS. 1A to 1C.

Referring to FIGS. 2A and 2B, the glass unit 100B may include a first outer glass plate 110 and a second outer glass plate 130 facing each other, and a plurality of inner glass plates (i.e., a first inner glass plate 121 and a second inner glass plate 122) between the first outer glass plate 110 and the second outer glass plate 130. The first inner glass plate 121 may include a first main surface 121M1 facing a second main surface 110M2 of the first outer glass plate 110, a second main surface 121M2 facing a first main surface 122M1 of the second inner glass plate 122, and a circumference 121E extending between the first main surface 121M1 and the second main surface 121M2. The second inner glass plate 122 may include the first main surface 122M1 facing the second main surface 121M2 of the first inner glass plate 121, a second main surface 122M2 facing a first main surface 130M1 of the second outer glass plate 130, and a circumference 122E extending between the first main surface 122M1 and the second main surface 122M2. Each of a thickness t2-1 between the first main surface 121M1 and the second main surface 121M2 of the first inner glass plate 121 and a thickness t2-2 between the first main surface 122M1 and the second main surface 122M2 of the second inner glass plate 122 may be smaller than each of a thickness t1 of the first outer glass plate 110 and a thickness t3 of the second outer glass plate 130. The detailed description of the first inner glass plate 121 and the second inner glass plate 122 may be the same as the description of the inner glass plate 120 given with reference to FIGS. 1A to 1C.

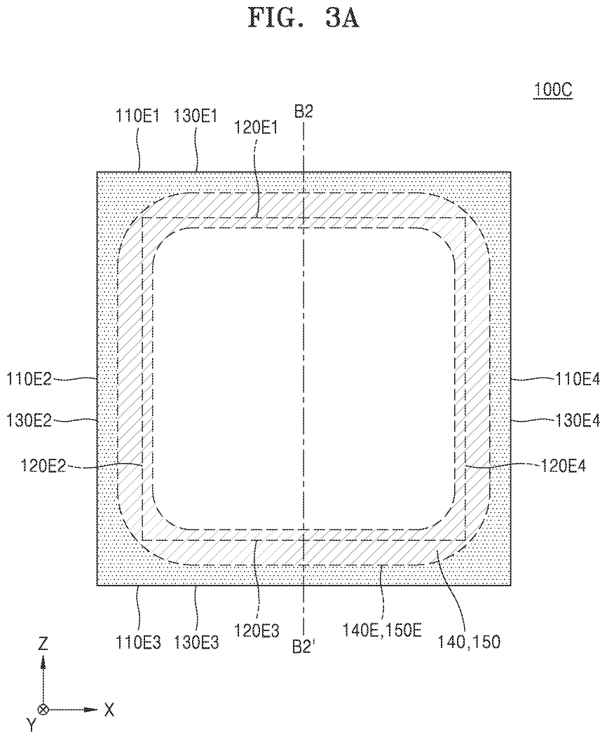

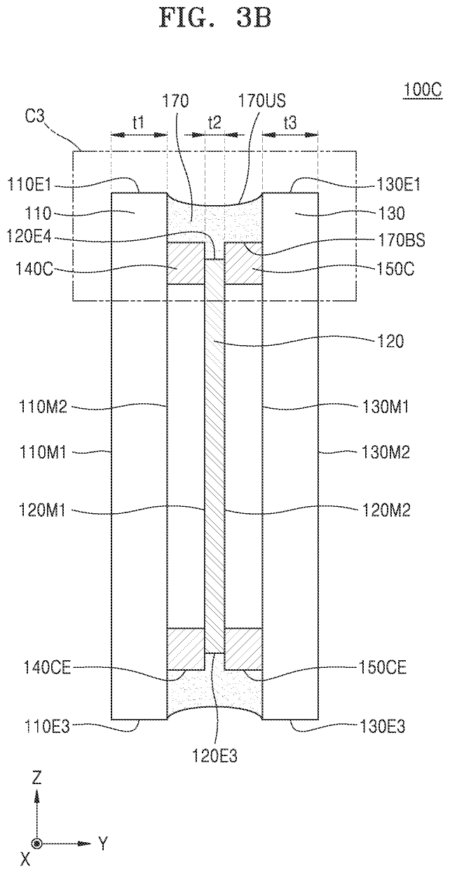

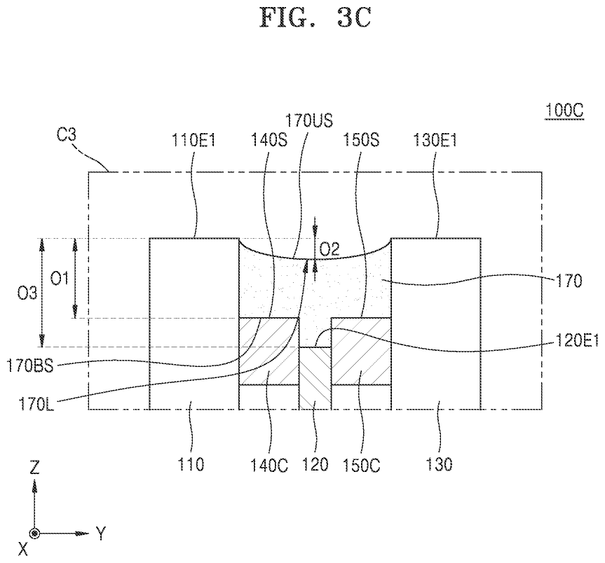

FIG. 3A is a plan view of a glass unit 100C according to an embodiment, and FIG. 3B is a cross-sectional view taken along line B2-B2′ of FIG. 3A. In addition, FIG. 3C is an enlarged view of a portion C3 of FIG. 3B. Hereinafter, the description of FIGS. 3A to 3C will be given on the basis of differences from the glass unit 100A illustrated in FIGS. 1A to 1C.

Referring to FIGS. 3A to 3C, a portion of a first spacer 140C and a portion of a second spacer 150C may protrude outside a circumference of an inner glass plate 120. In other words, a circumference 140CE of the first spacer 140C and a circumference 150CE of the second spacer 150C may be offset outwards from the circumference of the inner glass plate 120. For example, the circumference 140CE of the first spacer 140C and the circumference 150CE of the second spacer 150C may be offset outwards (in a −Z direction) from a third edge surface 120E3 of the inner glass plate 120. The portion of the first spacer 140C and the portion of the second spacer 150C may protrude outside the circumference of the inner glass plate 120, and thus, the first spacer 140C and the second spacer 150C may further protect the inner glass plate 120 from damage due to physical contact and/or impact. Accordingly, the glass unit 100C may have more improved durability.

However, as in the glass unit 100A illustrated in FIGS. 1A to 1C, the first spacer 140C and the second spacer 150C may still be offset inward from a circumference of a first outer glass plate 110 and a circumference of a second outer glass plate 130. For example, the circumference 140CE of the first spacer 140C and the circumference 150CE of the second spacer 150C may be offset inward (in a +Z direction) from a third edge surface 110E3 of the first outer glass plate 110 and a third edge surface 130E3 of the second outer glass plate 130. The portion of the first spacer 140C and the portion of the second spacer 150C, which protrude outside the circumference of the inner glass plate 120, may be spaced apart from each other.

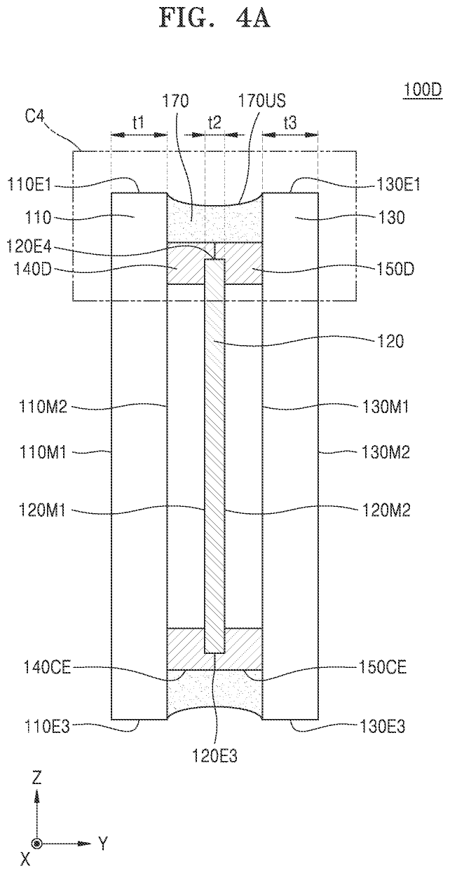

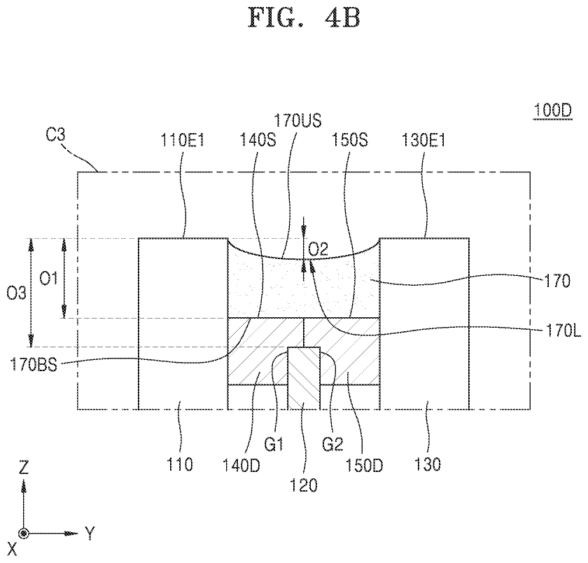

FIG. 4A is a cross-sectional view of a glass unit 100D according to an embodiment, and FIG. 4B is an enlarged view of a portion C4 of FIG. 4A. Hereinafter, the description of FIGS. 4A and 4B will be given on the basis of differences from the glass unit 100A illustrated in FIGS. 1A to 1C.

Referring to FIGS. 4A and 4B, a portion of a first spacer 140D and a portion of a second spacer 150D, which protrude outside a circumference of an inner glass plate 120, may contact each other. In some embodiments, the portion of the first spacer 140D and the portion of the second spacer 150D, which protrude outside the circumference of the inner glass plate 120, may contact the circumference of the inner glass plate 120. For example, the first spacer 140D and the second spacer 150D may contact a third edge surface 120E3 of the inner glass plate 120. In some embodiments, the inner glass plate 120 may be seated within a groove G1 of the first spacer 140D, and the inner glass plate 120 may be seated within a groove G2 of the second spacer 150D. The circumference of the inner glass plate 120 may be protected by the first spacer 140D and the second spacer 150D, and thus, the first spacer 140D and the second spacer 150D may further protect the inner glass plate 120 from damage due to physical contact and/or impact. Accordingly, the glass unit 100D may have more improved durability.

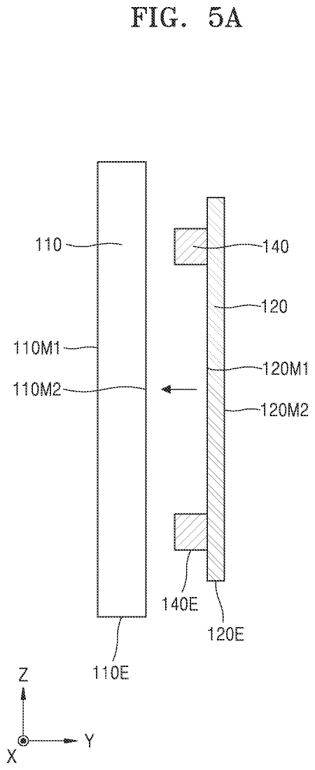

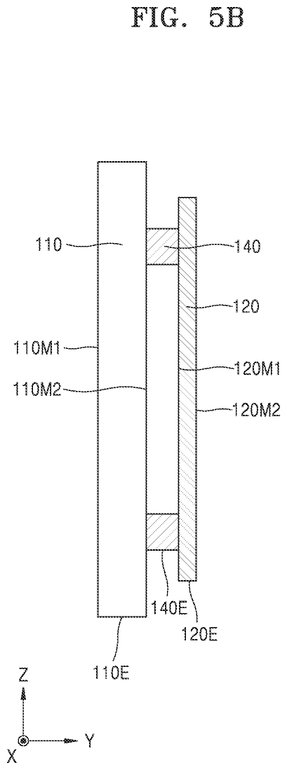

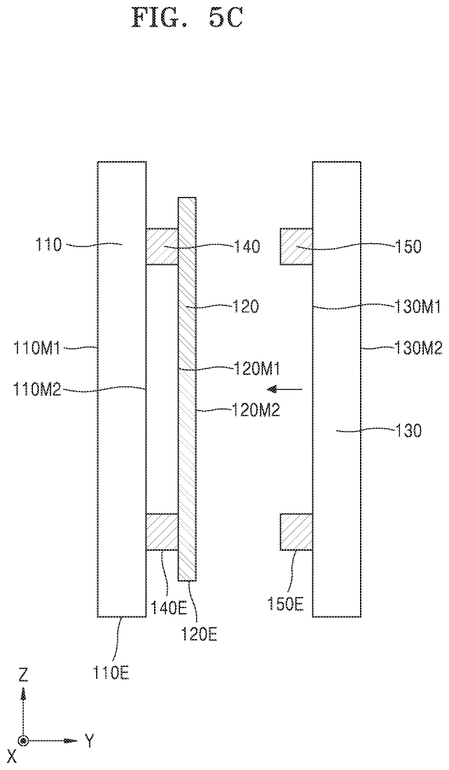

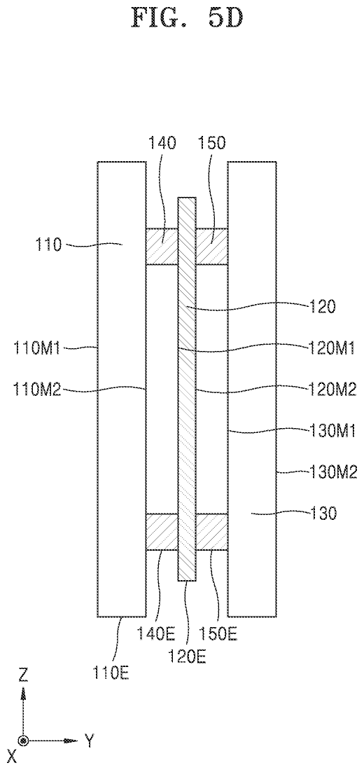

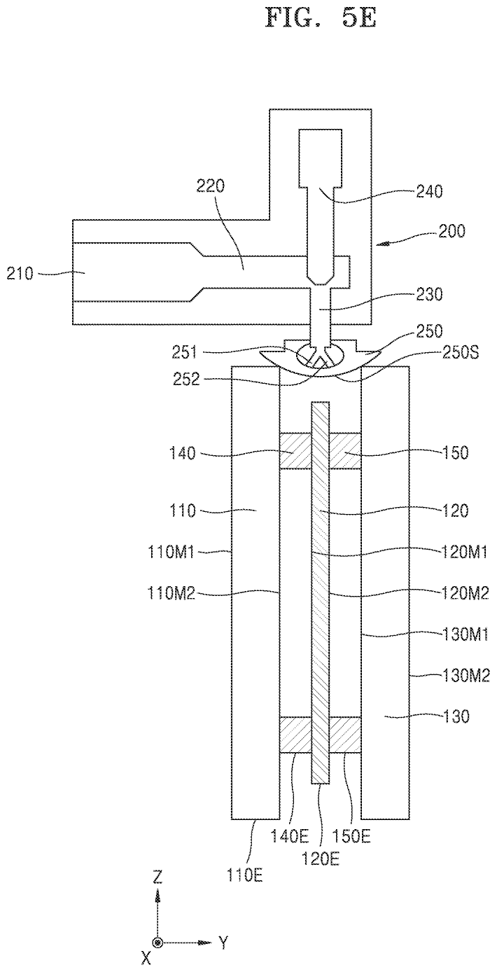

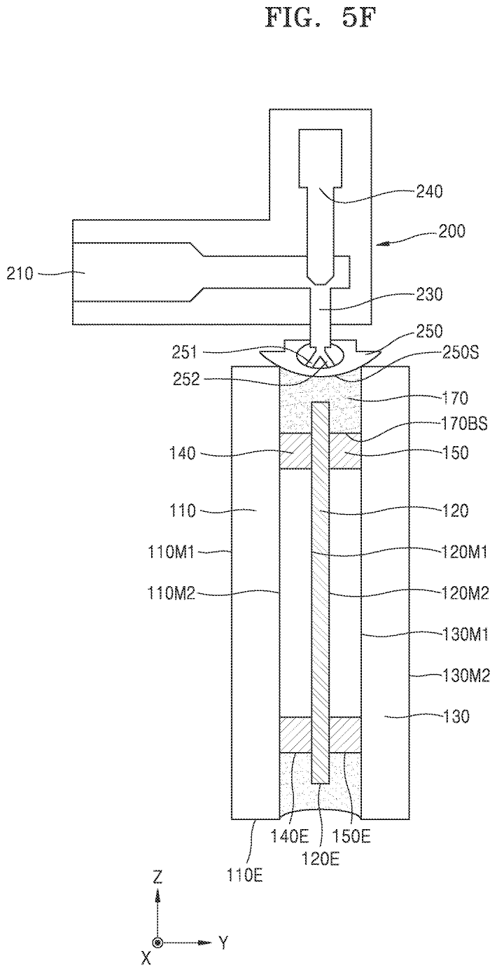

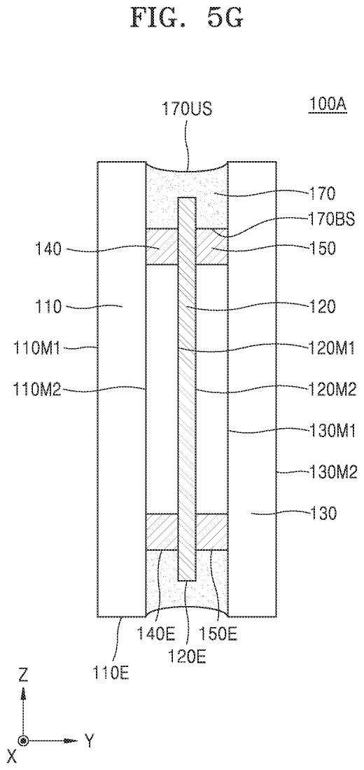

FIGS. 5A to 5G are cross-sectional views sequentially illustrating a process of manufacturing the glass unit 100A, according to an embodiment.

Referring to FIGS. 5A and 5B, a first spacer 140 may be attached onto a first main surface 120M1 of an inner glass plate 120 such that a circumference 140E of the first spacer 140 is offset inward from a circumference 120E of the inner glass plate 120. Subsequently, the inner glass plate 120 may be attached onto a second main surface 110M2 of a first outer glass plate 110 via the first spacer 140 such that the circumference 120E of the inner glass plate 120 is offset inward from a circumference 110E of the first outer glass plate 110.

Referring to FIGS. 5C and 5D, a second spacer 150 may be attached onto a first main surface 130M1 of a second outer glass plate 130 such that a circumference 150E of the second spacer 150 is offset inward from a circumference 130E of the second outer glass plate 130. Subsequently, the second outer glass plate 130 may be attached onto a second main surface 120M2 of the inner glass plate 120 via the second spacer 150 such that the circumference 120E of the inner glass plate 120 is offset inward from the circumference 130E of the second outer glass plate 130 and the circumference 150E of the second spacer 150 is offset inward from the circumference 120E of the inner glass plate 120.

Referring to FIGS. 5E, 5F, and 5G, a sealing member manufacturing equipment 200 may be arranged above the inner glass plate 120 arranged between the first outer glass plate 110 and the second outer glass plate 130. The sealing member manufacturing equipment 200 may include a sealing material supply unit 210 configured to accommodate a sealing material. In addition, the sealing member manufacturing equipment 200 may include a first pipe 220 extending in one direction (e.g., a +Y direction) from the sealing material supply unit 210, and a second pipe 230 integrally formed with the first pipe 220. Here, the second pipe 230 may extend in a direction (e.g., a −Z direction) orthogonal to the one direction in which the first pipe 220 extends. The sealing member manufacturing equipment 200 may include a supply adjuster 240 configured to move in the same direction as the direction in which the second pipe 230 extends. When the supply adjuster 240 moves toward the inner glass plate 120, a passage of the first pipe 220 is closed, and thus, the supply of a sealing material supplied from the sealing material supply unit 210 is blocked. In contrast, when the supply adjuster 240 moves in a direction opposite to a direction toward the inner glass plate 120, the passage of the first pipe 220 is opened, and thus, the supply of the sealing material supplied from the sealing material supply unit 210 is resumed.

According to an embodiment, the sealing member manufacturing equipment 200 may include a sealing material nozzle block 250 configured to discharge the sealing material toward a space between the first outer glass plate 110 and the second outer glass plate 130. A plurality of nozzles (i.e., a first nozzle 251 and a second nozzle 252) may be arranged inside the sealing material nozzle block 250. Here, the first nozzle 251 may be arranged to face a space between the first outer glass plate 110 and the inner glass plate 120, and the second nozzle 252 may be arranged to face a space between the second outer glass plate 130 and the inner glass plate 120. The first nozzle 251 and the second nozzle 252 may be configured to simultaneously supply the sealing material to the space between the first outer glass plate 110 and the inner glass plate 120 and the space between the second outer glass plate 130 and the inner glass plate 120, respectively.

A bottom surface 250S of the sealing material nozzle block 250 may be a curved surface that is convexly formed. When the first nozzle 251 and the second nozzle 252 of the sealing material nozzle block 250 discharge the sealing material, the sealing material fills the space between the first outer glass plate 110 and the inner glass plate 120 and the space between the second outer glass plate 130 and the inner glass plate 120. When the sealing material fully fills the space between the first outer glass plate 110 and the inner glass plate 120 and the space between the second outer glass plate 130 and the inner glass plate 120, a sealing member 170 may be completed. Here, an upper surface 170US of the sealing member 170 may be a curved surface that is concavely formed in contact with the bottom surface 250S of the sealing material nozzle block 250. When the sealing member 170 is formed, the glass unit 100A is completed.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A glass unit comprising:
a first outer glass plate and a second outer glass plate facing each other;
an inner glass plate arranged between the first outer glass plate and the second outer glass plate;
a first spacer arranged between the first outer glass plate and the inner glass plate to space the inner glass plate apart from the first outer glass plate;
a second spacer arranged between the second outer glass plate and the inner glass plate to space the inner glass plate apart from the second outer glass plate; and
a sealing member buried in a space between the first outer glass plate and the inner glass plate and a space between the second outer glass plate and the inner glass plate, wherein an upper surface of the sealing member includes a curved surface that is concavely formed.

2. The glass unit of claim 1, wherein an upper surface of the first outer glass plate is located on a same plane as an upper surface of the second outer glass plate, and an upper surface of the inner glass plate is offset from the upper surface of the first outer glass plate by a first distance.

3. The glass unit of claim 2, wherein a lowest point of the upper surface of the sealing member is offset from the upper surface of the first outer glass plate by a second distance, and the first distance is greater than the second distance.

4. The glass unit of claim 3, wherein a central point of the upper surface of the sealing member includes the lowest point of the upper surface of the sealing member.

5. The glass unit of claim 1, wherein a thickness of the inner glass plate is smaller than each of a thickness of the first outer glass plate and a thickness of the second outer glass plate, and a composition of the inner glass plate is different from each of a composition of the first outer glass plate and a composition of the second outer glass plate.

6. The glass unit of claim 5, wherein the thickness of the inner glass plate is about 0.2 mm to about 1.0 mm.

7. The glass unit of claim 1, wherein a bottom surface of the sealing member opposite to the upper surface of the sealing member has an uneven shape.

8. The glass unit of claim 1, wherein each of the first outer glass plate and the second outer glass plate includes soda lime glass, and the inner glass plate includes boroaluminosilicate glass.

9. The glass unit of claim 1, wherein a thermal expansion coefficient of the inner glass plate is smaller than each of a thermal expansion coefficient of the first outer glass plate and a thermal expansion coefficient of the second outer glass plate.

10. The glass unit of claim 1, wherein both outer surfaces of the sealing member are in contact with the first outer glass plate and the second outer glass plate, respectively.

11. A glass unit comprising:
a first outer glass plate and a second outer glass plate facing each other;
a first inner glass plate arranged between the first outer glass plate and the second outer glass plate;
a first spacer arranged between the first outer glass plate and the first inner glass plate to space the first inner glass plate apart from the first outer glass plate;
a second spacer arranged between the second outer glass plate and the first inner glass plate to space the first inner glass plate apart from the second outer glass plate; and
a sealing member buried in a space between the first outer glass plate and the first inner glass plate and a space between the second outer glass plate and the first inner glass plate, wherein a circumference of the first inner glass plate is offset inward from a circumference of the first outer glass plate and a circumference of the second outer glass plate, and an upper surface of the sealing member includes a curved surface that is concavely formed.

12. The glass unit of claim 11, further comprising:
a second inner glass plate arranged between the first inner glass plate and the second outer glass plate, and spaced apart from the first inner glass plate by the second spacer; and
a third spacer arranged between the second outer glass plate and the second inner glass plate to space the second inner glass plate apart from the second outer glass plate.

13. The glass unit of claim 11, wherein a distance between a vertical level of an upper surface of the first inner glass plate and a vertical level of an upper surface of the first outer glass plate is greater than a distance between a vertical level of an upper surface of the first spacer and the vertical level of the upper surface of the first outer glass plate.

14. The glass unit of claim 13, wherein the upper surface of the first inner glass plate is offset from the upper surface of the first outer glass plate by a first distance, a lowest point of the upper surface of the sealing member is offset from the upper surface of the first outer glass plate by a second distance, and the first distance is greater than the second distance.

15. The glass unit of claim 11, wherein the first spacer and the second spacer contact each other.

16. The glass unit of claim 11, wherein a solar absorption rate of the first inner glass plate is lower than each of a solar absorption rate of the first outer glass plate and a solar absorption rate of the second outer glass plate.

17. The glass unit of claim 11, wherein a solar transmittance of the first inner glass plate is greater than each of a solar transmittance of the first outer glass plate and a solar transmittance of the second outer glass plate.

18. A method of manufacturing a glass unit, the method comprising:
attaching a first spacer onto an inner glass plate;
attaching the inner glass plate onto a first outer glass plate via the first spacer such that a circumference of the inner glass plate is offset inward from a circumference of the first outer glass plate;
attaching a second spacer onto a second outer glass plate;
attaching the second outer glass plate to the inner glass plate via the second spacer such that the circumference of the inner glass plate is offset inward from a circumference of the second outer glass plate;
on an upper surface of the first spacer and an upper surface of the second spacer, filling, via a sealing material nozzle block, a sealing material into a space between the first outer glass plate and the second outer glass plate; and
forming a sealing member by filling the sealing material in the space between the first outer glass plate and the second outer glass plate.

19. The method of claim 18, wherein a bottom surface of the sealing material nozzle block in contact with an upper surface of the sealing member includes a curved surface that is convexly formed toward the inner glass plate.

20. The method of claim 19, wherein the upper surface of the sealing member includes a curved surface that is concavely formed toward the inner glass plate.
